(19) United States
(12) Patent Application Publication
(10) Pub. No.: US 2012/0192411 A1
(43) Pub. Date: Aug. 2, 2012

(54) METHOD FOR ELECTRICAL CONNECTION BETWEEN TWO SURFACES OF CERAMIC SUBSTRATE

(76) Inventors: Yau-Hung Chiou, Taipei City (TW); Shu-Hui Fan, Hsinchu County (TW); Ming-Tze Kao, Taipei City (TW)

(21) Appl. No.: 13/166,525

(22) Filed: Jun. 22, 2011

(30) Foreign Application Priority Data
Jan. 28, 2011 (TW) 100103522

(51) Int. Cl. H01R 43/00

(52) U.S. Cl. 29/825

(57) ABSTRACT

The present invention discloses a method for electrical connection between two surfaces of a ceramic substrate, and the method includes the steps of forming a through hole between the two surfaces of the ceramic substrate corresponding to electrical connection points of a circuit on the ceramic substrate, and then mounting a conductive assembly inside the through hole to form a conduction path between the two surfaces of the ceramic substrate. By this means, time cost of manufacturing of ceramic substrate circuit board could be largely decreased, and the manufacturing procedures could be much simplified as well.

### BACKGROUND OF THE INVENTION

1. Field of the Invention

The present invention relates to a method for an electrical connection between two surfaces of a ceramic substrate, and more particularly to a manufacturing process technology that uses a dry implanting nail as a means for an electrical connection between two surfaces of a substrate.

2. Brief Description of Related Art

At present, ceramic substrate used extensively in the electronic industry becomes an important board material for printed circuit boards. For example, the surface of an LED ceramic substrate is electroplated, such that both surfaces of the substrate can be used for circuit layout and configuration.

In the conventional circuit manufacturing process of a ceramic substrate, it is necessary to connect separate circuit points on both surfaces of the substrate or perform a thermal conduction treatment between both surfaces of the substrate. Since it is not easy to lay the circuit to the periphery of the substrate, therefore most manufacturers select a process of drilling a hole at a near position, and the electroplating or electroforming deposition is selected for filling conductive metal materials (such as copper) into the through hole. However, such method has to lengthen the duration for the electroplating and is laborious in the work during the actual manipulation as electrical characteristics are concerned, and the parameters including current, voltage, chemical concentration and operating temperature must be controlled accurately. Furthermore, it is difficult to control the quality, and a void through hole which is not filled completely may result easily and causes a bottleneck of controlling the yield rate. In view of the aforementioned difficulties, the inventor of the present invention based on years of experience in the related industry to conduct extensive researches and experiments and finally designed a method for an electrical connection between two surfaces of a ceramic substrate, in hope of overcoming the shortcomings of the prior art and improve the industrial application.

### SUMMARY OF THE INVENTION

In view of the existing drawbacks of the prior art, it is a primary objective of the present invention to provide a method for an electrical connection between two surfaces of a ceramic substrate to overcome the difficulty of the prior art.

To achieve the foregoing objective, the present invention provides a method for an electrical connection between two surfaces of a ceramic substrate, comprising the following steps:

A. Substrate Boring Step: A through hole is formed at electric connection points disposed on both surfaces of a ceramic substrate;

B. Nailing Step: An electrically conductive element is fixed into the through hole to serve as an electrical conductive path of both surfaces of the ceramic substrate after the through hole is formed in the substrate boring step (Step A); and

C. Electric Connection Enhancement Step: A layer of electrically conductive material is coated at both ends of the electrically conductive element and the corresponding electrical connection points.

Wherein, the electrically conductive element is a cylindrical assembly or a nail assembly in a shape corresponding to the through hole, and the electrically conductive element is made of gold, silver or copper, and after the electrically conductive element is fixed to the through hole, both ends of the electrically conductive element are aligned evenly with both surfaces of the ceramic substrate, and both surfaces of the ceramic substrate are in contact with the electrical connection points on both surfaces, and the through hole is formed by using a drilling tool, and the through hole can be a circular hole or an irregular shaped hole.

In the method for an electrical connection between two surfaces of a ceramic substrate in accordance with the present invention, the through hole is designed and disposed between the two surfaces of the ceramic substrate, and an electrically conductive element is fixed into the through hole and used as an electrical connection path for the circuits on both surfaces of the ceramic substrate. Such arrangement not only saves lots of time and enhances the convenience of the manufacturing process, but also overcomes the difficulties of the conventional ways of controlling the yield rate and facilitates the application in the production process. The technical characteristics of the present invention will become apparent with the detailed description of preferred embodiments and related drawings as follows.

### BRIEF DESCRIPTION OF THE DRAWINGS

FIG. 1 is a flow chart of a method for an electrical connection between two surfaces of a ceramic substrate in accordance with the present invention;

FIG. 2 is a cross-sectional side view of a first part of a method for an electrical connection between two surfaces of a ceramic substrate in accordance with a preferred embodiment of the present invention;

FIG. 3 is a cross-sectional side view of a second part of a method for an electrical connection between two surfaces of a ceramic substrate in accordance with a preferred embodiment of the present invention; and

FIG. 4 the present invention is a cross-sectional side view of a third part of a method for an electrical connection between two surfaces of a ceramic substrate in accordance with a preferred embodiment of the present invention.

### DETAILED DESCRIPTION OF THE PREFERRED EMBODIMENTS

To make it easier for our examiner to understand the technical characteristics, contents, advantages, and effects of the present invention, preferred embodiments together with related drawings are provided for describing and illustrating the invention. These preferred embodiments are provided for the purpose of illustration only, but not intended for limiting the scope of the invention.

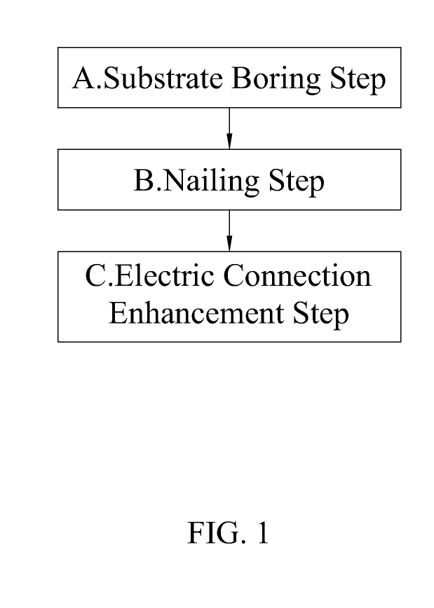

With reference to FIG. 1 for a method for an electrical connection between two surfaces of a ceramic substrate in accordance with a preferred embodiment of the present invention, the method comprises the following steps:

A. Substrate Boring Step;

B. Nailing Step; and

C. Electric Connection Enhancement Step.

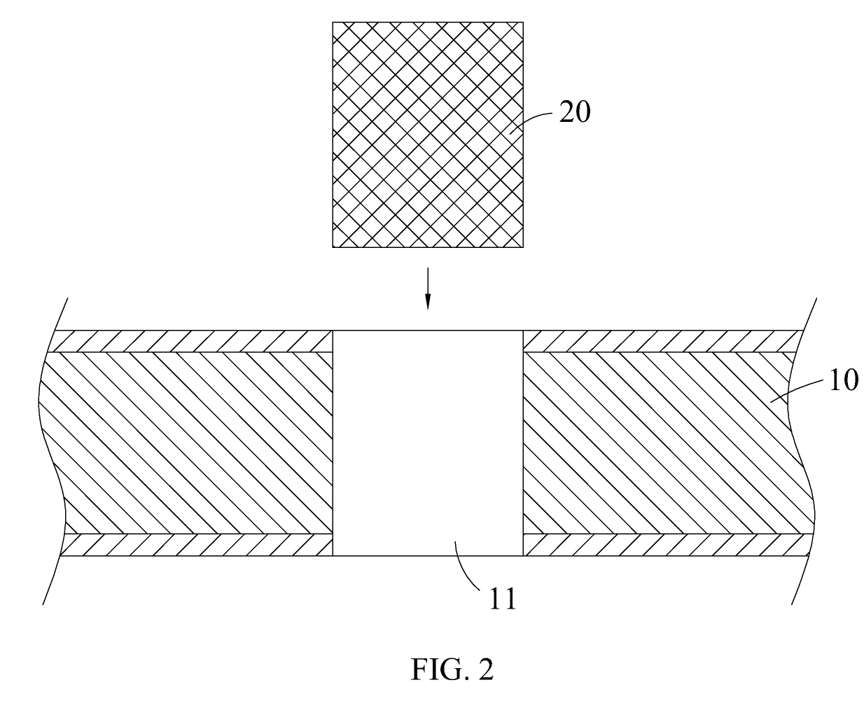

In FIG. 2, after the substrate boring step (Step A) takes place, a through hole is formed at electrical connection points on both surfaces of the ceramic substrate (10) by a tool after circuits are laid, such that a through hole (11) which can be a circular hole or an irregular shaped hole is formed.

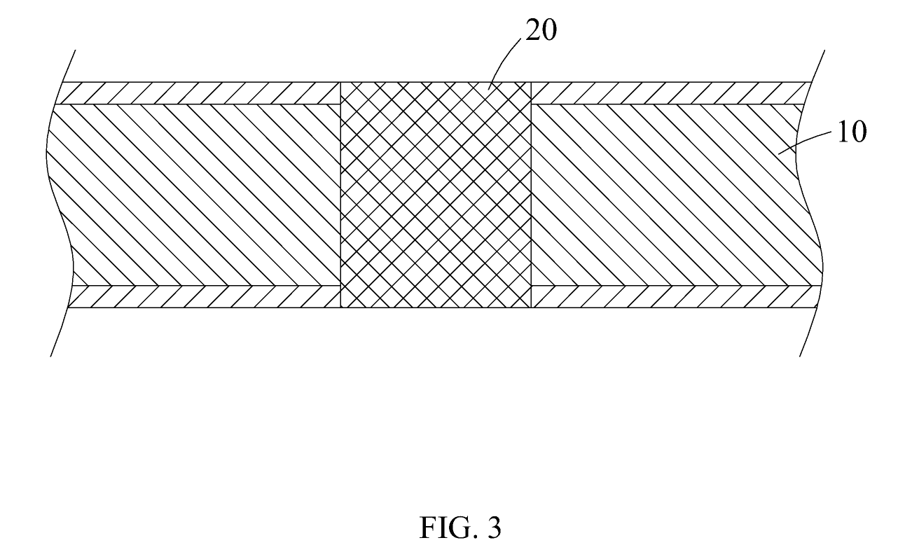

In FIG. 3, after the nailing step (Step B) takes place, an electrically conductive element (20) is passed and fixed into the through hole (11), wherein the electrically conductive element (20) can be a cylindrical assembly or a nail assembly in a shape matched with the through hole (11), and the electrically conductive element (20) can be made of gold, silver or copper, and it can be a rigid body or a flexible body. After the electrically conductive element (20) is fixed into the through hole (11), both ends of the electrically conductive element (20) are aligned evenly with both surfaces of the ceramic substrate (10) and contacted with the electrical connection points on both surfaces to serve as an electric conduction path for both surfaces of the ceramic substrate (10).

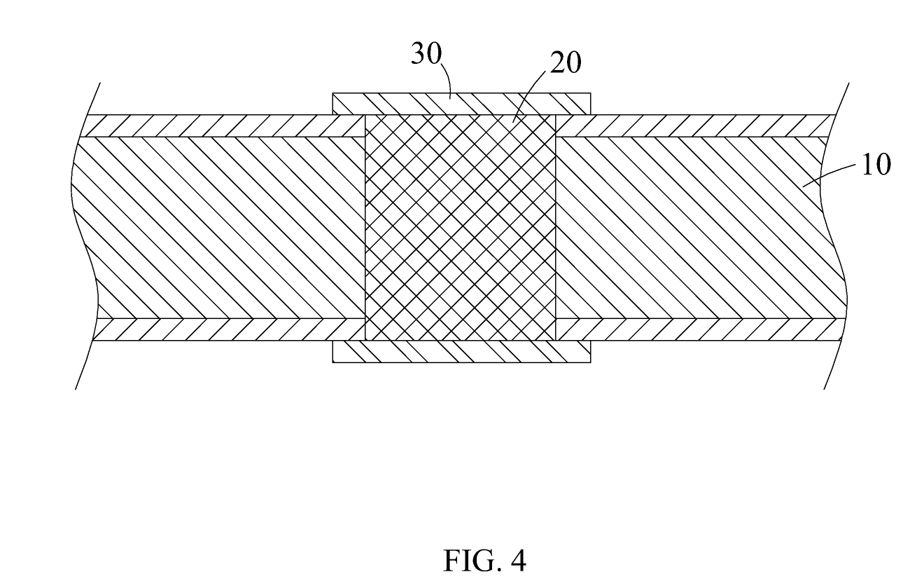

In FIG. 4, the electric connection enhancement step (Step C) takes place after the nailing step (Step C), wherein a layer of electrically conductive material (30) is coated between both ends of the electrically conductive element (20) and the electrical connection points for enhancing the electric connection, and the electrically conductive material (30) can be tin.

In the method for an electrical connection between two surfaces of a ceramic substrate of the present invention, the through hole (11) is formed between the two surfaces of the ceramic substrate (10), and the electrically conductive element (20) is fixed into the through hole (11) to serve as an electrical connection path of circuits on the two surfaces of the ceramic substrate (10), such that the invention can save lots of operating time and make the manufacturing process more convenient than the traditional way of electroplating and filling the through hole (11). The invention can avoid the difficulty of controlling the yield rate and facilitate the practical application to the production process.

In summation of the description above, the present invention breaks through the prior art, achieves the expected effect and complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A method for an electrical connection between two surfaces of a ceramic substrate, comprising the steps of:
(a) a substrate boring step, forming a through hole at electrical connection points to penetrate through the two surfaces of the ceramic substrate; and
(b) a nailing step, passing and fixing an electrically conductive element into the through hole to serve as an electric conduction path for the two surfaces of the ceramic substrate after the through hole is formed in the substrate boring step.

2. The method for an electrical connection between two surfaces of a ceramic substrate as recited in claim 1, further comprising an electric connection enhancement step of coating a layer of electrically conductive material between both ends of the electrically conductive element and the corresponding electrical connection points, after the nailing step taking place.

3. The method for an electrical connection between two surfaces of a ceramic substrate as recited in claim 1, wherein the electrically conductive element is a cylindrical assembly or a nail assembly in a shape matched with the through hole.

4. The method for an electrical connection between two surfaces of a ceramic substrate as recited in claim 1, wherein the electrically conductive element is a rigid body or a flexible body.

5. The method for an electrical connection between two surfaces of a ceramic substrate as recited in claim 1, wherein the electrically conductive element is made of gold, silver or copper.

6. The method for an electrical connection between two surfaces of a ceramic substrate as recited in claim 1, wherein after the electrically conductive element is fixed into the through hole, both ends of the electrically conductive element are aligned evenly with both surfaces of the ceramic substrate and contacted with the electrical connection points on both surfaces.

7. The method for an electrical connection between two surfaces of a ceramic substrate as recited in claim 1, wherein the through hole is formed by a drilling tool.

8. The method for an electrical connection between two surfaces of a ceramic substrate as recited in claim 1, wherein the through hole is a circular hole or an irregular shaped hole.
